(19) United States
(12) Patent Application Publication
(10) Pub. No.: US 2012/0106158 A1
(43) Pub. Date: May 3, 2012

(54) ILLUMINATED SERVING TRAY WITH SHEET-LIKE LIGHT SOURCE

(75) Inventor: Dirk Hubert Vaessen, Duesseldorf (DE)

(73) Assignee: KONINKLIJKE PHILIPS ELECTRONICS N.V., EINDHOVEN (NL)

(21) Appl. No.: 13/260,778

(22) PCT Filed: Mar. 24, 2010
(86) PCT No.: PCT/IB2010/051266

§ 371 Date: Dec. 27, 2011

(30) Foreign Application Priority Data
Mar. 31, 2009 (EP) 09156791.7

(51) Int. Cl. F21V 33/00

(52) U.S. Cl. 362/253

(57) ABSTRACT

The invention describes an illuminated serving tray that comprises a platter (1) through which light can pass, at least one sheet-like light source (7, 7′) disposed beneath the platter (1) for illuminating the illuminated serving tray and/or food (4), drinks (5) or other articles placed on the illuminated serving tray. The sheet-like light source (7, 7′) radiates light uniformly and thus producing uniform illumination of the objects placed on the illuminated serving tray. The illuminated serving tray may also comprise a cover (3) which may also be illuminated by the sheet-like light source (7, 7′). A system for charging the rechargeable energy storage devices (8) is also described. A method of changing the appearance of the illuminated serving tray, using at least partly reflective matter (11) is also disclosed.

### FIELD OF THE INVENTION

The present invention relates to illuminated serving trays.

### BACKGROUND OF THE INVENTION

The U.S. Pat. No. 5,430,628 describes a lighted illuminated serving tray comprised of a discus shaped platter with an interior hollow in which a tubular light array is positioned. The tray includes a serving surface upon which drink glasses are to be placed, and which includes a clear, lens portion through which light is transmitted to illuminate an etched sponsor logo. A change/power case is affixed to the tray to house a power supply and to provide a change compartment for use by wait staff. The light transmission plate comprises a central, lens section which is fabricated to be substantially clear and a surrounding, annular frosted section which is textured.

A disadvantage of the illuminated serving tray disclosed by the patent cited above is that the illumination produced by it is not uniform.

### SUMMARY OF THE INVENTION

An object of the present invention is to provide an illuminated serving tray having a more uniform illumination.

The object of the invention is achieved by providing an illuminated serving tray comprising a platter through which light can pass, at least one sheet-like light source disposed beneath the platter for illuminating the illuminated serving tray and/or the food, drinks or other articles placed on the illuminated serving tray. A sheet-like light source has the advantage that it produces light of substantially the same intensity from every point of its light producing area. Thus, the illumination produced by it is substantially uniform.

An illuminated serving tray according to the present invention comprises a platter made of a suitable material such as, for example, glass, ceramic or Plexiglas®. The platter allows at least some light to pass through it. In other words, it is at least partially transparent or translucent. It may be clear or colored as well. A sheet-like light source, for example an Organic Light Emitting Diode (OLED) or an Electroluminescent Device (ELD), is disposed beneath the platter such that at least a part of the light produced by the sheet-like light source, when it is electrically energized, is radiated in the direction of the bottom surface of the platter, the top surface of which is referred to as the serving surface. The light produced by the sheet-like light source passes through the platter to its top surface and illuminates the platter and/or the food, drinks or other articles placed on the illuminated serving tray. An advantage of the illuminated serving tray according to the present invention is that the sheet-like light source radiates light through the platter uniformly. In other words the light intensity at any lighted point on the serving surface is essentially the same as at any other lighted point on the serving surface. Thus, an object placed anywhere on the lighted part of the serving surface will be illuminated with light of the same intensity. A further advantage is that there is no need for features such as a frosted surface or light out-coupling to make the illumination on the serving surface uniform.

In an embodiment of the invention the illuminated serving tray comprises a sheet-like light source wherein the sheet-like light source is an Organic Light Emitting Diode. An OLED of either of the two types, generally known as top emitting and bottom emitting, may be used. In either case, the OLED is oriented in the illuminated serving tray such that the light emitted by it is radiated towards the platter. When a top emitting OLED is used, the glass substrate of the OLED may form the bottom surface of the illuminated serving tray. An advantage of this construction is that the illuminated serving tray does not need additional protection at the bottom. This results in the further advantage that the illuminated serving tray is very thin and light. This might be desirable aesthetically.

The structures of OLEDs are well known to a skilled person. The structure of the various layers of material and the constructional features may be found in many sources. The published patent application WO 2006/040704 A1 assigned to the present applicant is one such and the contents of the document are incorporated herein by reference.

In another embodiment of the illuminated serving tray according to the invention, the sheet-like light source is a transparent Organic Light Emitting Diode. A transparent OLED is also known as a double side emitting OLED. That is, the OLED disposed below the platter, radiates light both towards the platter (upwards) and away from it (downwards). An advantage of this is that the tray will be visible when carried aloft, for example by a waiter, even in a dimly lit bar or restaurant. This has the additional advantage that it could be aesthetically more appealing. Alternatively, when the illuminated serving tray is placed on a table, the top surface of the table below and around the illuminated serving tray is also illuminated and highlights the tray and the food, drinks or other articles placed on it.

In another practical embodiment of the illuminated serving tray according to the present invention, the illuminated serving tray comprises a fixed or detachably attached cover, for at least enclosing the Organic Light Emitting Diode. Such a cover has the advantage that it protects the transparent OLED from abrasion and ingress of moisture. It has a further advantage that the material and properties of the material from which the cover is made, may be so chosen as to realize further advantageous features of the illuminated serving tray. Some of the materials and their properties and the advantages realized from their use are described below in an exemplary manner. However, the list is not exhaustive and should not be construed to be limiting to the scope of the invention.

The cover could be made of, for example, transparent, clear Plexiglas®, or glass. When the cover is made of such a material, the light from the transparent OLED radiates outwards unimpeded from the bottom of the illuminated serving tray also and the bottom of the illuminated serving tray is also lit. Alternatively, the material, instead of being clear, could be colored. In that case, the light emanating from the bottom of the illuminated serving tray will have the same color as that of the cover, if the light emitted by the transparent OLED is white. Alternatively, if the light emitted by the transparent OLED is of a certain color, the bottom of the illuminated serving tray will have a color that is a combination of the color of the light emitted by the transparent OLED and the color of the cover. A resultant color of a combination of two other colors is well known and documented. Thus, if covers of different colors are made available, one can choose the cover to obtain a desired color for the cover when the OLED is energized. This could be used advantageously to better present the food, drinks or other articles placed on the illuminated serving tray. For instance the color could be chosen to enhance the color of the table top or the cloth on the table.

In a further embodiment of the illuminated serving tray according to the present invention the illuminated serving tray comprises a cover that is, at least partly, made of translucent frosted material. The material of the cover could be translucent ceramic, various types of translucent plastics, clear materials with frosted surfaces or a clear material which is imprinted with translucent inks, etc., and combinations of such materials and surface features. This has the effect that the light emanating from the bottom part of the illuminated serving tray is diffuse and soft. One has a very large range of materials in combination with methods of their treatment to create an extraordinarily large variety of such covers to fulfill practical and aesthetic needs.

Still further, it is also possible to use opaque material for the cover. This has the effect that the bottom of the illuminated serving tray itself is not illuminated and at least a part of the light emitted downwards by the transparent OLED is reflected towards the top and hence alters the visual properties of the light emanating from the top. Depending on the optical properties of the inside surface of the cover various effects could be achieved. For example, the inside surface of the cover could be colored and highly reflective to change the brightness and color of the light emanating from the top of the illuminated serving tray. Alternatively, the surface could be made to be a mirror with a coating of aluminum or another suitable metal. This will have the effect that almost all the light radiated from the bottom of the transparent OLED is reflected upwards and blends with the light radiated upwards by the transparent OLED to emanate from the top surface of the illuminated serving tray.

Another distinct advantage of using a transparent OLED is that the appearance of the illuminated serving tray, when not energized, is also controllable. Explaining further, in an illuminated serving tray with a single side emitting OLED the surface of the substrate facing the platter may have a mirror finish. Thus, the illuminated serving tray, when the OLED is not energized, has a mirror like appearance. In contrast, with an illuminated serving tray comprising a transparent OLED, the inner surface of the cover is visible though the top surface of the illuminated serving tray when the transparent OLED is not energized. Thus, different illuminated serving trays having covers with different visual characteristics of the inner surface of the cover will have different appearances when the transparent OLED is not energized. This could be used to advantage.

It is obvious that the cover could be made of a combination of the materials and properties described hitherto and a great variety of effects could be achieved. Thus, this choice has the advantage that it offers a variety of design choices to the designer and to the user of the illuminated serving trays.

In a further embodiment of the illuminated serving tray according to the present invention, the cover is attached in the illuminated serving tray with at least one element of the group of clamps, bayonet connectors, screws, matching threads, and adhesives. The cover of the illuminated serving tray may be fitted in the illuminated serving tray either in a fixed manner or a detachably attached manner.

The means with which the cover is fitted in the illuminated serving tray determines if the cover is attached in a fixed or permanent manner, a semi permanent manner or in a replaceable manner. The method of fixing the cover in the illuminated serving tray is a matter of design choice and a person skilled in the art may choose the best method suited for specific requirements.

In a particularly advantageous embodiment of an illuminated serving tray according to the present invention, the illuminated serving tray comprising a transparent OLED and a cover, comprises a receptacle, arranged between the transparent OLED and the bottom surface of the cover, for receiving an at least partly reflective matter for reflecting at least a part of the light of the transparent OLED, the at least partly reflective matter being arranged preferably in a replaceable manner. This has the effect that the at least partly reflective matter (referred to as “insert” hereafter), inserted or placed in the receptacle, reflects at least a part of the light emitted by the transparent OLED, and the insert is visible through the serving surface of the illuminated serving tray. The advantage of such an arrangement is that different inserts containing different pictures or graphics of other nature, different text or a combination of the two could be created by the user or the designer of the tray, and inserted into the receptacle for viewing through the serving surface of the illuminated serving tray. Thus, the insert will have different appearances depending on whether the transparent OLED is energized or not.

For example, a circular sheet of plastic with the logo of a producer of a beverage, with the logo printed with a reflective ink, could be inserted into a circular receptacle in the cover, with its printed face facing upwards. Then, the logo printed with reflective ink reflects the light emitted by the transparent OLED and is distinctly visible through the serving surface of the illuminated serving tray. Advantageously, this may act as a source of income for the user of the illuminated serving tray, say a bar or restaurant, from the producer of the beverage whose logo is displayed in this manner. Innumerable materials and colors and methods of creating the reflective matter can be thought of by a person skilled in the art and all such variants are under the scope of the present invention.

The receptacle could be on the inner surface of the cover. In such a case the insert can be inserted into the receptacle by separating the cover from the illuminated serving tray, inserting the insert into the receptacle and then restoring the cover into the illuminated serving tray. However, it is possible that the cover is affixed in the tray in a non-removable or permanent manner. Then the receptacle may, for example, be provided such that it is accessible from outside the cover. In such a case, the part of the receptacle facing the OLED and the platter will be transparent. The shapes, materials, positions and processes mentioned above are only illustrative and should not be construed as restrictive to the scope of the invention in any manner.

In another advantageous embodiment according to the present invention, the illuminated serving tray just described may preferably have the at least partly reflective matter being made of one or more metals or metal alloys, or a material coated with one or more metals and/or metal alloys. The insert to be inserted or placed in the receptacle could be advantageously made of metals or alloys or a combination of the two or by coating or depositing other materials with metals or alloys or a combination of them. This has the advantage that most metals are naturally reflective and their surfaces may be finished in different ways and made at least partly reflective. The metallic areas could be burnished, roughened or ground, to name just a few of the surface finishes possible, to achieve different effects. Moreover, most metals are malleable and hence can be made into thin sheets that are also reasonably stiff so that it is easy to insert them in the receptacles. Further, a sheet of plastic may be coated with metals and alloys to form different patterns that are also at least partly reflective. Various methods of coating or depositing metals and/or alloys on plastics such as electroplating, electro-deposition, sputtering are well known in the art and a person skilled in the art can make a suitable choice of the method. The materials and processes mentioned above are only illustrative and should not be construed as restrictive to the scope of the invention in any manner.

In a still further embodiment of the illuminated serving tray according to the present invention just described, the partly reflective matter is at least partly coated with a phosphorescent and/or fluorescent material. The effect of having phosphorescent and/or fluorescent material is that the insert will glow and further highlight the inserts. This has the advantage that apart from the light reflected by the insert, there is additional light providing different visual effects from the phosphorescent or fluorescent material. With phosphorescent material, even without the transparent OLED being energized, there may be some light visible in the dark. This is advantageous in that the illuminated serving tray and/or the insert in the receptacle are visible even in the dark.

The power necessary to energize the sheet-like light source and a switch to turn on/off the sheet-like light source of the illuminated serving tray according to the present invention may be provided in a known way. For example, the power source could be one or more standard battery cells such as AA or AAA cells, rechargeable cells such as Nickel-Cadmium or Lithium ion or any of the numerous other known types, or rechargeable, compact, high capacitance capacitors with very low leakage currents generally known as super capacitors or ultra capacitors. These may be arranged to be installed in a replaceable manner in a known way. For aesthetic and protective reasons they may be arranged inside a frame provided on the illuminated serving tray so that they are not normally visible when the tray is in use. For the rechargeable energy sources, for example, rechargeable cells or super capacitors, recharging arrangements could be made in a known way. Suitable connectors could be provided to receive charging power from an external source.

In a particularly advantageous embodiment of the illuminated serving tray according to the present invention, the illuminated serving tray comprises a receiver part of an inductive power transfer system for receiving power, by induction, in order to operate the Organic Light Emitting Diode.

The power for energizing the illuminated serving tray for recharging the rechargeable energy storage devices in it could be supplied without conductive electrical connections. The power could be transferred to the illuminated serving tray inductively.

An inductive power transfer system, in general, comprises a transmitting part that generates an alternating magnetic field and a receiving part that receives the alternating magnetic field and by induction generates a current, which is then used to power a device.

In an embodiment of the illuminated serving tray according to the present invention, an article of furniture houses the transmitting part of an inductive power transfer system. The illuminated serving tray comprises a receiver part of the inductive power transfer system. When the transmitting part generates an alternating magnetic field, it is received by the receiving part in the illuminated serving tray and the power is used immediately to energize the sheet-like light source of the illuminated serving tray. It is also conceivable that the energy so received is used, first, to charge a rechargeable power source and use the energy so stored therein for powering the illuminated serving tray at a later time, whenever needed. Further it is possible to receive the power transmitted by way of the alternating magnetic field and use the power so received to simultaneously recharge a rechargeable power source and also power the illuminated serving tray. The use of any one of these methods is within the scope of this embodiment of the present invention.

The advantage of the method of powering the illuminated serving tray according to this embodiment is that the connectors necessary for receiving the recharging energy could be dispensed with and hence the construction, handling and maintenance of the illuminated serving tray is simpler. Further, the rechargeable energy storage devices used in the illuminated serving tray could be of relatively small size as it can be so arranged that the illuminated serving trays, when not in use, are placed in a suitable place equipped with a transmitting part of an inductive power transfer system so that they are charged. This has the advantage that the space required for housing the rechargeable energy storage devices in an illuminated serving tray is less and hence more area of the serving surface of the platter may be available. Since the rechargeable sources are charged frequently, whenever they are not in use, they are always ready for use.

In a particularly useful embodiment of the present invention, an illuminated serving tray contains no rechargeable energy storage devices at all and has only a receiving part of an inductive power transfer system. An article of furniture on which the illuminated serving tray is placed during use, for example a customer's table in a restaurant or a bar, is equipped with a transmitting part of the inductive power transfer system. Thus, when a user, for example a waiter, places the illuminated serving tray on such a table, for example, the OLED lights up automatically since the receiving part in it receives the power transmitted by the transmitting part in the customers table and supplies it to the OLED, after suitable processing, as needed.

It is a further object of the present invention to provide an illuminated serving tray system comprising an illuminated serving tray according to the present invention comprising a receiving part of an inductive power transfer system, an article of furniture for receiving the illuminated serving tray, the article of furniture comprising a transmitter part of an inductive power transfer system for generating an alternating magnetic field for transferring power inductively to the illuminated serving tray. The system for inductively transferring power to the illuminated serving tray consists essentially of two parts. A first part, the transmitter part, is housed in an article of furniture, for example, a rack or a table, and comprises a transmitter coil and electronic circuits for sending an alternating current into the transmitter coil. A second part, the receiving part, is housed within the illuminated serving tray, and may comprise, for example, a planar coil and one or more rectifying elements to rectify a current generated by the coil. The alternating current in the transmitter coil generates an alternating magnetic field. When the receiver coil, in this case housed in the illuminated serving tray, is in the proximity of the transmitter coil, the alternating magnetic field induces an alternating current in the receiver coil. This current may be used for charging a rechargeable power source, if the illuminated serving tray is equipped with it, or energize an OLED of the illuminated serving tray or do both simultaneously.

The article of furniture could be a shelf or rack for holding more than one illuminated serving tray at a time, with all the illuminated serving trays placed in them receiving power, inductively, simultaneously. This may be used for charging the rechargeable power source of the illuminated serving tray while being stored.

Alternatively the article of furniture may be a dining table, a side table or a center table on which illuminated serving trays are normally placed. The table top may be provided with transmitter coils, for example underneath the table top, and connected to the transmitter circuitry, in such a way that at least when required, the coil transmits an alternating magnetic field. When an illuminated serving tray is placed on such a table top, alternating current is generated in the receiver coil and which may be used for charging a rechargeable power source, if the illuminated serving tray is equipped with it, or to energize an OLED of the illuminated serving tray or do both simultaneously.

An Organic Light Emitting Diode configured to be suitable for use in the illuminated serving tray of any of the embodiments of this invention is also within the scope of this invention. Even though OLEDs may be manufactured in different configurations and sizes for general use, it is advantageous to manufacture OLEDs specifically for use in an illuminated serving tray. Alternatively, for using a generally available OLED in an illuminated serving tray it may be necessary to make certain additional preparations to it. All such OLEDs for use in illuminated serving trays are within the scope of this invention.

It is a further object of the present invention to provide a method of changing the appearance of an illuminated serving tray according to an embodiment of the present invention, the method comprising the steps of accessing a receptacle, arranging an at least partially reflective matter between the Organic Light Emitting Diode and the bottom surface of the cover, preferably in a replaceable manner and restoring the position of the cover of the illuminated serving tray. A replaceable at least partially reflective matter or insert is placed in a receptacle that can be viewed through the platter. By replacing the insert, the user may change the appearance of the illuminated serving tray both when it is energized and not energized. If the cover is affixed in the illuminated serving tray in a fixed manner, the receptacle may have to be so designed as to be accessible without removing the cover. If the cover is detachably attached in the illuminated serving tray, the receptacle may be designed to accessible either by removing the cover or without removing the cover.

Other objects and features of the present invention will become apparent from the following detailed description in conjunction with the accompanying drawings. It is to be understood that the drawings are designed solely for the purpose of illustration and not as a definition of the limits of the invention.

### BRIEF DESCRIPTION OF THE DRAWINGS

FIG. 1 is a perspective view of an illuminated serving tray according to a first embodiment of the invention

FIG. 2 is a Cross-section of an illuminated serving tray according to a second embodiment of the invention

FIG. 3 is a diagrammatic view of a system comprising the illuminated serving tray and an article of furniture with a transmitter part of the inductive power transmitter system

### DETAILED DESCRIPTION OF EMBODIMENTS

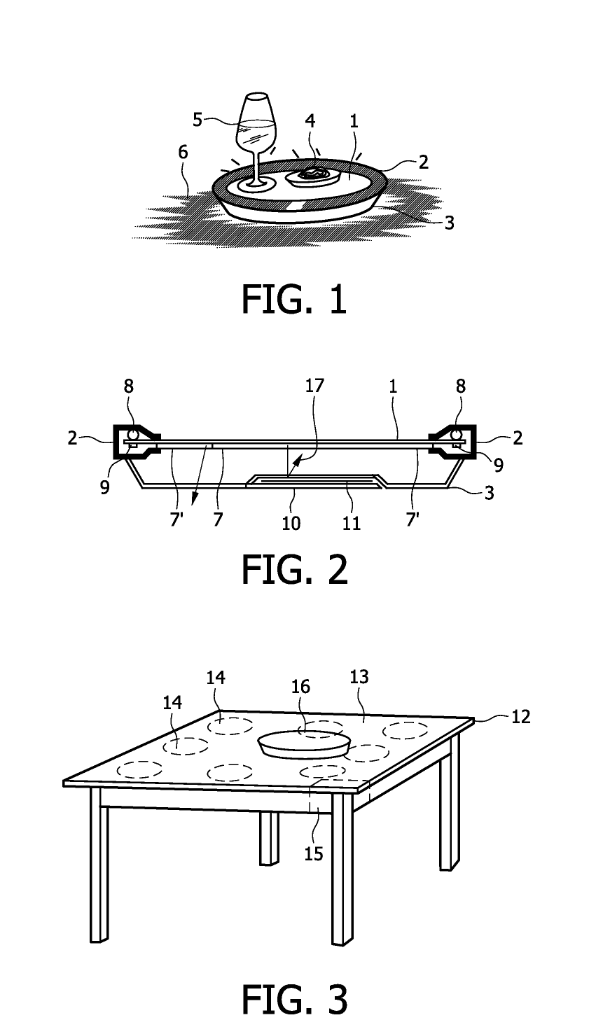

FIG. 1 shows a perspective view of an illuminated serving tray according to one of the embodiments of the present invention in use. A transparent glass plate 1 is the platter. The top surface of the glass plate is the serving surface. The illuminated serving tray has a cover 3 for example, made of a translucent material being fixed to the frame 2. A plate with a food article 4 on it and a glass 5 with a drink in it are shown placed on the illuminated serving tray. The light emitted by a transparent OLED (not shown) disposed below the platter 1 emanates through the platter 1 and illuminates the food 4 and the glass 5 with a drink in it placed on the platter and may also emanate through the translucent cover 3 and illuminates the cover 3 and the table top 6 on which the illuminated serving tray is placed.

FIG. 2 shows the cross section of an embodiment of the illuminated serving tray according to the present invention. Two concentric sheet-like light sources 7, 7′ are disposed below a glass platter 1. The two OLEDs could be of two different colors. The glass platter 1 has a frame 2 made of an opaque material. The sheet-like light sources 7, 7′ are transparent OLEDs. A cover 3 made of Plexiglas is disposed so as to cover the OLEDs 7, 7′ and is affixed to the frame 2 of the platter with glue. The area of the platter 1 covered by the frame 2 houses a number of rechargeable cells or super-capacitors 8. A planar coil 9 is also laid out under the frame 2. The two terminals of the coil are connected to a circuit (not shown) that receives the ac current generated by the planar coil, in the presence of a suitable alternating magnetic field. The Circuit converts the alternating current into a dc current, regulates it suitably and supplies it to the OLEDs. At the same time the circuit also generates a charging current to charge the rechargeable cells or super capacitors 8. In alternative embodiments only one OLED 7 are disposed below the glass platter 3.

The cover 3 comprises a receptacle 10 that accommodates a sheet of plastic 11 coated with different metals and alloys forming a logo. The logo is visible through the platter 1. The light generated by the OLED 7, 7′ in an upward direction passes through the platter directly, illuminating the food, drinks or other articles placed on the platter (not shown). A part of the light generated by the OLED 7, 7′ in a downward direction passes through the cover and illuminates the cover 3 itself and the surface on which the illuminated serving tray is placed. Another part of the light generated by the OLED 7, 7′ in a downward direction illuminates the sheet of plastic 11 and is reflected by it at least partly 17. In alternative embodiments the receptacle 10 may extend over the whole cover 3. The sheet of plastic 11 may fill the complete area of the receptacle 10 or a smaller part of it.

FIG. 3 shows an illuminated serving tray system according to the present invention. The dinner table 12 has a top surface 13. Underneath the top surface, a number of planar coils 14 are arranged. A driver 15 is also arranged below the table top which is configured to drive an alternating current into the coils 14. When an illuminated serving tray according to the present invention 16 is placed on the top surface 13 of the table, driver 15 sends alternating currents into one or more of the coils 14, underneath the table, proximate to the illuminated serving tray 16. In the presence of the alternating magnetic field generated by the currents in the coils, the receiver coils in the illuminated serving tray generate a current that drives the OLED in the tray lighting up the articles placed on it. The driver itself may receive electrical power from the mains or from rechargeable power source to which it is connected.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single unit, for example, may fulfill the functions of several units recited in the claims. The mere fact that certain measures are recited in mutually different dependent claims does not indicate that a combination of these measures cannot be used to advantage.

Any reference signs in the claims should not be construed as limiting the scope.

### LIST OF REFERENCE SIGNS

1 Platter
2 Frame
3 Cover
4 Food
5 Glass with a drink in it
6 Table top
7 Sheet-like light source
8 Super capacitors
9 Planar coil
10 Receptacle
11 Insert
12 Table
13 Top surface of the table
14 Planar Coils
15 Driver
16 Illuminated serving tray
17 Reflected light

1. An illuminated serving tray comprising:
a platter through which light can pass;
at least one sheet-like light source comprising at least one transparent Organic Light-Emitting Diode and disposed beneath the platter for illuminating the illuminated serving tray and/or food, drinks or other articles placed on the illuminated serving tray.

2-3. (canceled)

4. The illuminated serving tray according to claim 1, comprising a fixed or detachably attached cover enclosing at least the Organic Light Emitting Diode.

5. The illuminated serving tray according to claim 4, wherein the cover is, at least partly, made of translucent frosted material.

6. The illuminated serving tray according to claim 4, wherein the cover is attached in the illuminated serving tray with at least one element selected from the group consisting of: clamps, bayonet connectors, screws, matching threads, and adhesives.

7. The illuminated serving tray according to claim 4 comprising:
a receptacle arranged between Organic Light Emitting Diode and the bottom surface of the cover for receiving an at least partly reflective matter, for reflecting back at least a part of the light of the Organic Light Emitting Diode, the at least partly reflective matter arranged preferably in a replaceable manner.

8. The illuminated serving tray according to claim 7, wherein the at least partially reflective matter is decorative or informative in nature, for viewing through the platter, such matter being made of one or more metals or metal alloys, or a material coated with one or more metals and/or metal alloys.

9. The illuminated serving tray according to claim 7, wherein the surface of the at least partly reflective matter facing the Organic Light Emitting Diode is at least partly coated with a phosphorescent and/or fluorescent material.

10. The illuminated serving tray according to claim 1, comprising a receiving part of an inductive power transfer system for receiving power, by induction, in order to operate the Organic Light Emitting Diode.

11. An illuminated serving tray system comprising:
an illuminated serving tray according to claim 10;
an article of furniture for receiving the illuminated serving tray,
the article of furniture further comprising a transmitter part of an inductive power transfer system for generating an alternating magnetic field for transferring power inductively to the illuminated serving tray.

12. (canceled)

13. A method of changing the appearance of an illuminated serving tray according to claim 7, the method comprising the steps of:
accessing the receptacle;
arranging an at least partially reflective matter between the Organic Light Emitting Diode and the bottom surface of the cover, preferably in a replaceable manner; and
restoring the position of the cover of the illuminated serving tray.
